(19) United States
(12) Patent Application Publication
(10) Pub. No.: US 2020/0402485 A1
(43) Pub. Date: Dec. 24, 2020

(54) Musical Instrument Retainer

(71) Applicant: Idaresit James Udofia, Fresh Meadows, NY (US)

(72) Inventor: Idaresit James Udofia, Fresh Meadows, NY (US)

(21) Appl. No.: 16/447,585

(22) Filed: Jun. 20, 2019

(51) Int. Cl. G10G 5/00

(52) U.S. Cl. CPC G10G 5/00

(57) ABSTRACT

A guitar neck retainer releasably secures a guitar to a guitar stand having neck stops spaced apart so as to receive the neck of the guitar therebetween. The retainer includes an elongated, longitudinally resiliently stretchable strap having two ends. A flexible touch fastener is permanently attached to one end of the strap. The touch fastener is configured to be secured about a first neck stop of the stand to releasably attach the retainer to the first neck stop. A rigid hook is permanently attached to the other end of the strap. The hook defines a crook sized to receive a second neck stop of the stand to releasably attach the retainer to the second neck stop.

### TECHNICAL FIELD

This description relates generally to a musical instrument retainer, for example, to a musical instrument retainer for releasably securing a musical instrument to a musical instrument stand.

### BACKGROUND

A musical instrument may be placed on a musical instrument stand when not in use. However, musical instrument stands vary in length and width. A traditional lock device may be incompatible with stands of differing dimensions. A musical instrument can therefore fall off or slide off such stands. Moreover, traditional lock devices for musical instrument stands are often easily removed and misplaced or lost.

### SUMMARY

A guitar neck retainer is disclosed for releasably securing a neck of a guitar to a guitar stand. The guitar stand has neck stops spaced apart so as to receive the neck of the guitar therebetween. In some embodiments, the guitar neck retainer includes an elongated, longitudinally resiliently stretchable strap having two distal ends. A flexible touch fastener is permanently attached to one of the distal ends of the strap. The touch fastener is configured to be secured about a first of the neck stops of the guitar stand to releasably attach the retainer to the first neck stop of the guitar stand. A rigid hook is permanently attached to the other of the distal ends of the strap. The hook defines a crook sized to receive a second of the neck stops of the guitar stand to releasably attach the retainer to the second neck stop of the guitar stand. The retainer is of a length that, with the retainer positioned to prevent removal of the neck of the guitar from between the neck stops, with the touch fastener secured about the first neck stop and the hook attached to the second neck stop, the strap is held in a stretched condition.

In some embodiments, a musical instrument retainer is disclosed for releasably securing a musical instrument to a musical instrument stand. The musical instrument stand has stops spaced apart so as to receive the musical instrument therebetween. The retainer includes an elongated, longitudinally resiliently stretchable strap having two distal ends. A flexible touch fastener is attached to one of the distal ends of the strap. The touch fastener is configured to be secured about a first of the stops of the musical instrument stand to releasably attach the musical instrument retainer to the first stop of the musical instrument stand. A rigid hook is attached to the other of the distal ends of the strap. The hook defines a crook sized to receive a second of the stops of the musical instrument stand to releasably attach the retainer to the second stop of the musical instrument stand.

In some embodiments, a musical instrument retainer is disclosed for releasably securing a musical instrument to a musical instrument stand. The musical instrument stand has stops spaced apart so as to receive the musical instrument therebetween. The retainer includes an elongated, longitudinally resiliently stretchable strap having two distal ends. A flexible touch fastener is attached to one of the distal ends of the strap. The touch fastener is configured to be secured about a first of the stops of the musical instrument stand to releasably attach the musical instrument retainer to the first stop of the musical instrument stand. A ring is attached to the other of the distal ends of the strap. The ring defines an opening sized to receive a second of the stops of the musical instrument stand to releasably attach the retainer to the second stop of the musical instrument stand.

These and other aspects, features, and implementations can be expressed as methods, apparatus, systems, components, means, or steps for performing a function, and in other ways.

These and other aspects, features, and implementations will become apparent from the following descriptions, including the claims.

### BRIEF DESCRIPTION OF THE DRAWINGS

FIG. 1 shows a perspective view of an example musical instrument retainer attached to a musical instrument stand.

FIG. 2 shows a perspective view of another example musical instrument retainer securing a musical instrument to a musical instrument stand.

FIG. 3 shows a perspective view of an example musical instrument retainer securing a musical instrument to a musical instrument stand.

FIG. 4 shows a perspective view of yet another example musical instrument retainer.

FIG. 5 shows a perspective view of yet another example musical instrument retainer.

FIG. 6 shows a perspective view of yet another example musical instrument retainer.

### DETAILED DESCRIPTION

A musical instrument retainer is disclosed for securing a musical instrument to a musical instrument stand. The retainer is compatible with a variety of musical instrument stands that have stops spaced apart so as to receive a musical instrument therebetween. The retainer includes an elongated, longitudinally resiliently stretchable strap having two distal ends. The strap can be stretched across the musical instrument stand and is therefore compatible with stands of differing widths. A flexible touch fastener is attached to one of the distal ends of the strap. The touch fastener is configured to be secured about a first of the stops of the musical instrument stand to releasably attach the musical instrument retainer to the first stop of the musical instrument stand. The touch fastener can be tightly attached to the first of the stops and therefore cannot easily slip off the musical instrument stand and be lost or misplaced. A rigid hook is attached to the other of the distal ends of the strap. The hook defines a crook sized to receive a second of the stops of the musical instrument stand to releasably attach the retainer to the second stop of the musical instrument stand. In some embodiments, the crook is sized to receive a stop of round cross-section having a diameter of between 0.25 inches and 3 inches. The musical instrument can therefore be removed for use by a user from the stand by releasing the hook from the second of the stops.

Among other benefits and advantages of the embodiments disclosed, the musical instrument retainer is compatible with musical instrument stands of differing dimensions. The retainer can be left attached to an arm or a neck stop of the musical instrument stand and therefore cannot easily slip off the stand and be lost or misplaced. The strap can include a compartment sized to accommodate a portion of a guitar pick when the portion of the guitar pick is inserted into the compartment through an opening in the strap. The strap of the retainer can be painted or decorated, e.g., with a picture or a logo to appeal to different users. In this manner, the musical instrument retainer provides a user with a secure device to protect a musical instrument as well as a guitar pick when not in use by securely attaching or holding the musical instrument to a musical instrument stand.

### Perspective View of Example Musical Instrument Retainer

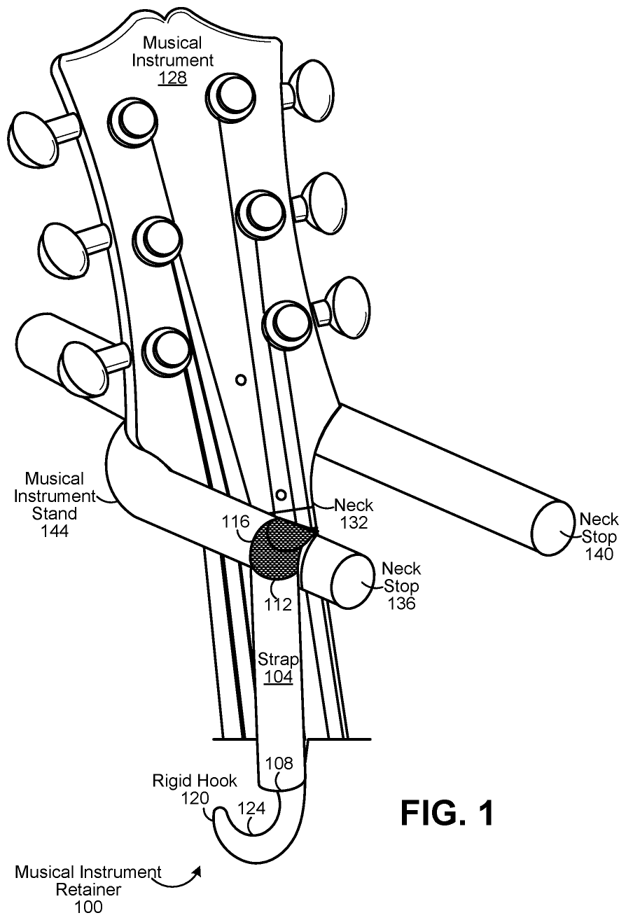

FIG. 1 shows a perspective view of an example musical instrument retainer 100 attached to a musical instrument stand 144. The musical instrument retainer 100 includes a strap 104, a flexible touch fastener 116, and a rigid hook 120.

FIG. 1 shows a musical instrument 128 placed on the musical instrument stand 144. In some embodiments, as shown in FIG. 1, the musical instrument retainer 100 is a guitar neck retainer configured to releasably secure a neck 132 of a guitar to a guitar stand. In other embodiments, the musical instrument retainer 100 can be used to releasably secure another musical instrument such as a ukulele, a violin, a bass, etc., to the musical instrument stand 144. In yet other embodiments, the musical instrument retainer 100 can be used to releasably secure the musical instrument 128 to a wall mounted stand. The musical instrument stand 144 has stops 136 and 140 that are spaced apart so as to receive the neck 132 of the musical instrument 128 therebetween. In some embodiments, as shown in FIG. 1, the stops 136 and 140 are neck stops of a guitar stand. In some embodiments, the stops 136 and 140 are spaced between 2 inches and 7 inches apart.

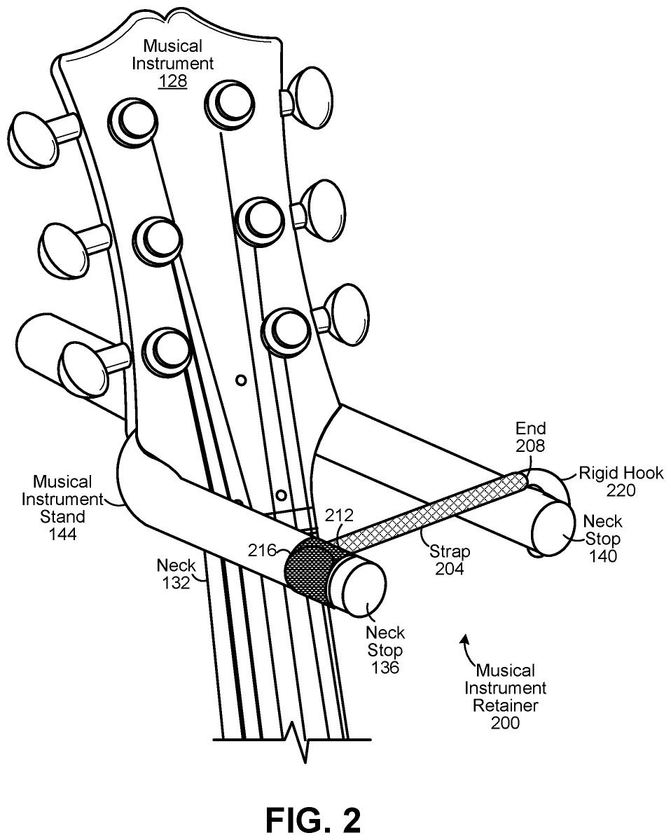

The musical instrument retainer 100 includes the strap 104, as illustrated in FIG. 1. The strap 104 is an elongated, longitudinally resiliently stretchable strap having two distal ends 108 and 112. In some embodiments, the strap 104 is formed of molded elastomeric polymer, an elastic fabric, rubber, polyester, spandex, any other stretchable material, or a combination thereof. In other embodiments as shown in FIG. 2 below, the strap 104 includes a length of bungee or shock cord. The strap 104 is configured to be stretched from the stop 136 to the stop 140. In some embodiments, the strap 104 is around 1 inch long when released or in an unstretched condition as shown in FIG. 1. For example, the strap 104 may be between 0.75 inches and 1.25 inches long when unstretched.

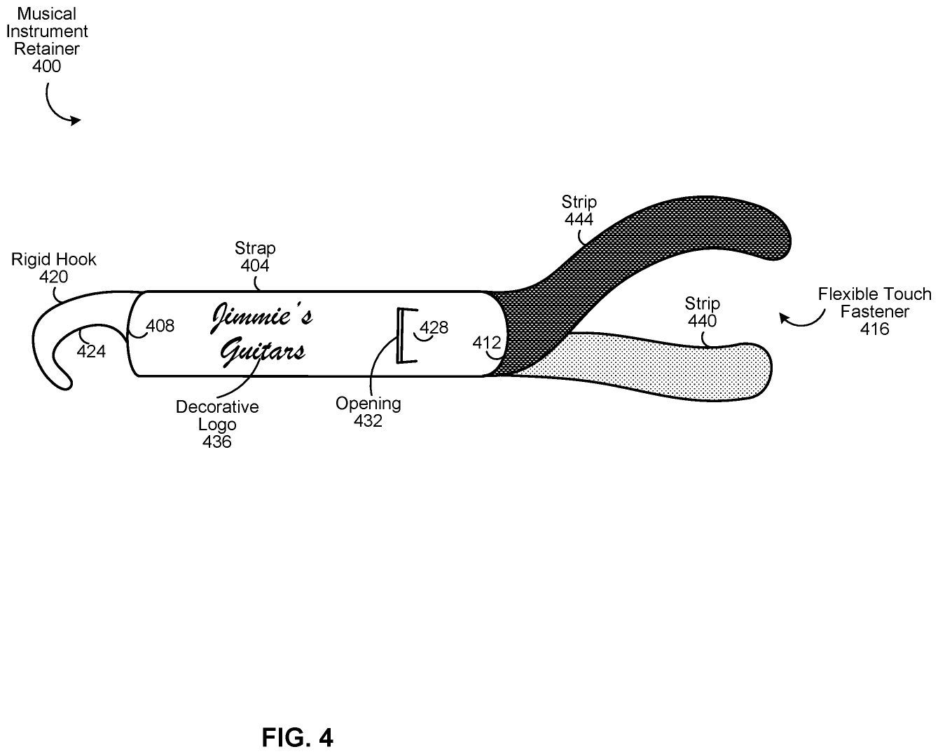

The musical instrument retainer 100 includes the flexible touch fastener 116 that is attached to the end 112 of the two distal ends 108, 112 of the strap 104. In some embodiments, the flexible touch fastener 116 is permanently attached to the end 112. The flexible touch fastener 116 can be sewn onto or glued onto the end 112. The flexible touch fastener 116 is of a length sufficient to be secured about the first stop 136 or a first arm of the musical instrument stand 144 to releasably attach the musical instrument retainer 100 to the first stop 136 or the first arm of the musical instrument stand 144. The flexible touch fastener 116 can be released from the first stop 136 of the musical instrument stand 144 to release the musical instrument retainer 100 from the musical instrument stand 144. In some embodiments, as shown in FIG. 1, the flexible touch fastener 116 is a strip of hook-and-loop fastening tape with hooks on one side and loops on the other side, so that the fastener 116 can be secured around an arm of a musical instrument stand and overlapped on itself with the hooks engaged with the loops. In other embodiments, as shown in FIG. 4 below, the flexible touch fastener includes two strips of hook-and-loop fastening tape extending separately from an end of the strap with hooks on one strip and loops on the other strip. Such a material is available from Velcro USA Inc.

The musical instrument retainer 100 includes the rigid hook 120 that is attached to the end 108 of the two distal ends 108, 112 of the strap 104. In some embodiments, the rigid hook 120 is permanently attached to the end 108. The rigid hook 120 can be glued or clamped onto the end 108 or otherwise attached to the end 108. In some embodiments, the rigid hook 120 is formed of plastic or metal. The rigid hook 120 defines a crook 124 that is sized to receive the second stop 140 or a second arm of the musical instrument stand 144 to releasably attach the musical instrument retainer 100 to the second stop 140 or the second arm of the musical instrument stand 144. In some embodiments, the crook 124 is sized to receive a stop 140 of round cross-section having a diameter of between 0.25 inches and 3 inches.

The musical instrument retainer 100 is of a length that, with the musical instrument retainer 100 positioned to prevent removal of the musical instrument 128 from between the stops 136, 140, with the flexible touch fastener 116 secured about the first stop 136 and the rigid hook 120 attached to the second stop 140, the strap 104 is held in a stretched condition. The musical instrument retainer 100 shown in FIG. 1 thus prevents the musical instrument 128 from sliding out of or falling off the musical instrument stand 144 when the musical instrument retainer 100 is positioned to prevent removal of the neck 132 of the musical instrument 128 from between the stops 136, 140.

### Perspective View of Example Musical Instrument Retainer

FIG. 2 shows a perspective view of another example musical instrument retainer 200 securing the musical instrument 128 to the musical instrument stand 144. The musical instrument retainer 200 includes a strap 204, a flexible touch fastener 216, and a rigid hook 220. The rigid hook 220 defines a crook as shown and described in more detail above with reference to FIG. 1.

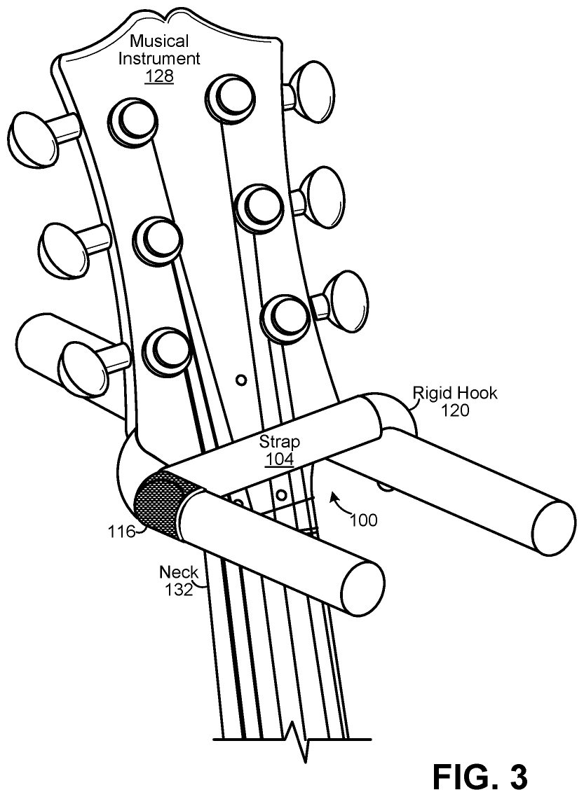

FIG. 2 shows the musical instrument retainer 200 in a stretched condition such that the musical instrument retainer 200 is securing the musical instrument 128 to the musical instrument stand 144. The strap 204 shown in FIG. 2 includes a length of bungee cord or shock cord that is stretched toward the stop 140 of the musical instrument stand 144 such that the musical instrument retainer 200 can be hooked onto the stop 140. The strap 204 has two distal ends 208, 212. In some embodiments, the strap 204 is between 2 inches and 7 inches long in the stretched condition. The musical instrument retainer 200 can be positioned on the musical instrument stand 144 as shown in FIG. 2 such that there is a spacing between the musical instrument retainer 200 and the musical instrument 128. The musical instrument retainer 200 is therefore not in contact with the musical instrument 128. The musical instrument 128 can therefore be slid a distance towards the musical instrument retainer 200 but the musical instrument 128 cannot slide off, fall off, or be removed from the musical instrument stand 144. Alternatively, the musical instrument retainer can be positioned on the musical instrument stand 144 as shown in FIG. 3 below such that the musical instrument retainer is in contact with the musical instrument 128.

The flexible touch fastener 216 is similar to the flexible touch fastener 116 shown and described in more detail above with reference to FIG. 1. The flexible touch fastener 216 is attached to the end 212 of the strap 204. The rigid hook 220 is similar to the rigid hook 220 shown and described in more detail above with reference to FIG. 1. The rigid hook 220 is attached to the end 208 of the strap 204. For example, the rigid hook 220 can be glued or clamped onto the end 208 or otherwise attached to the end 208.

### Perspective View of Example Musical Instrument Retainer

FIG. 3 shows a perspective view of the example musical instrument retainer 100 of the FIG. 1 securing the musical instrument 128 to the musical instrument stand 144. The musical instrument retainer 100 includes the strap 104, the flexible touch fastener 116, and the rigid hook 120 as shown and described in more detail above with reference to FIG. 1. FIG. 3 shows the musical instrument retainer 100 in a stretched condition. In some embodiments, the strap 104 is between 2 inches and 7 inches long in the stretched condition. As shown in FIG. 3, the flexible touch fastener 116 and the rigid hook 120 are positioned on or attached to the musical instrument stand 144 closer to the musical instrument 128 such that the musical instrument retainer 100 is in contact with or pressing against the musical instrument 128. The musical instrument 128 is thus secured to the musical instrument stand 144 more tightly than as shown above with reference to FIG. 2.

### Perspective View of Example Musical Instrument Retainer

FIG. 4 shows a perspective view of yet another example musical instrument retainer 400. The musical instrument retainer 400 includes a strap 404, a flexible touch fastener 416, and a rigid hook 420.

The strap 404 is similar to the strap 104 illustrated and described in more detail above with reference to FIG. 1. The strap 404 is an elongated, longitudinally resiliently stretchable strap having two distal ends 408, 412. In some embodiments, the strap 404 is formed of molded elastomeric polymer, an elastic fabric, rubber, polyester, spandex, any other stretchable material, or a combination thereof. In some embodiments, the strap 404 is around 1 inch long when released or in an unstretched condition. For example, the strap 404 may be between 0.75 inches and 1.25 inches long when unstretched.

In some embodiments, the strap 404 is painted, embroidered, or otherwise decorated with a picture, text, or a decorative logo 436 as shown in FIG. 4. In some embodiments, the strap 404 has a compartment 428 sized to accommodate a portion of a pick of the musical instrument 128, e.g., a guitar pick or a ukulele pick. For example, a corner of a guitar pick can be inserted into the compartment 428 such that 20-30% of the guitar pick is within the compartment 428. The strap 404 secures the portion of the pick within the compartment 428 when the portion of the pick is inserted into the compartment 428 through an opening 432 in the strap 404. The opening 432 can be a slit in the strap 404 or an opening of a pocket in the strap 404. The compartment 428 can be sized to accommodate other small objects such as a key, etc.

The musical instrument retainer 400 includes the flexible touch fastener 416 that is attached to the end 412 of the two distal ends 408, 412 of the strap 404. In some embodiments, the flexible touch fastener 416 is permanently attached to the end 412. The flexible touch fastener 416 can be sewn onto or glued onto the end 112. The flexible touch fastener 416 is of a length sufficient to be secured about the first stop 136 or a first arm of the musical instrument stand 144 to releasably attach the musical instrument retainer 400 to the first stop 136 as shown and described in more detail above with reference to FIG. 1. The flexible touch fastener 416 can be released from the first stop 136 of the musical instrument stand 144 to release the musical instrument retainer 400 from the musical instrument stand 144. In some embodiments, as shown in FIG. 4, the flexible touch fastener 416 includes two strips 440, 444 of hook-and-loop fastening tape extending separately from the end 412 of the strap 404 with hooks on one strip 440 and loops on the other strip 444. The strip 444 can be secured around an arm of the musical instrument stand 144 and the other strip 440 can be overlapped on the strip 444 with the hooks engaged with the loops.

The musical instrument retainer 400 includes the rigid hook 420 attached to the end 408. In some embodiments, the rigid hook 420 is permanently attached to the end 408. The rigid hook 420 can be glued or clamped onto the end 408 or otherwise attached to the end 408. In some embodiments, the rigid hook 420 is formed of plastic or metal. The rigid hook 420 defines a crook 424 that is sized to receive the second stop 140 or a second arm of the musical instrument stand 144 to releasably attach the musical instrument retainer 400 to the second stop 140 or the second arm. In some embodiments, the crook 424 is sized to receive a stop 140 of round cross-section having a diameter of between 0.25 inches and 3 inches.

### Perspective View of Example Musical Instrument Retainer

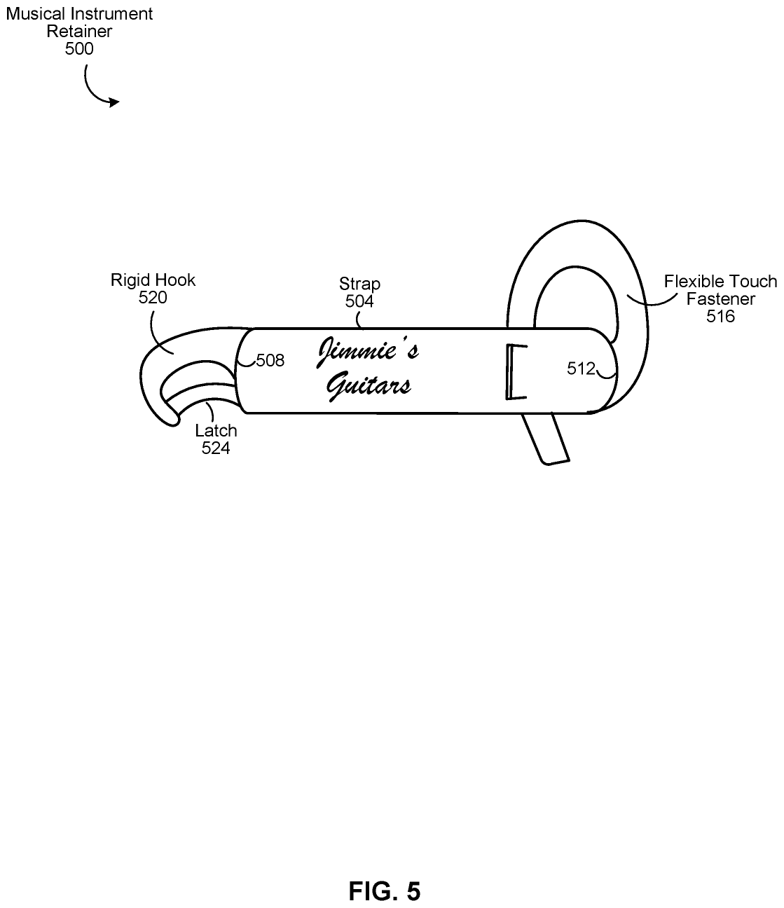

FIG. 5 shows a perspective view of yet another example musical instrument retainer 500. The musical instrument retainer 500 includes a strap 504, a flexible touch fastener 516, a rigid hook 520, and a latch 524. The strap 504 is similar to the strap 404 illustrated and described in more detail above with reference to FIG. 4.

The musical instrument retainer 500 includes the flexible touch fastener 516 that is attached to an end 512 of two distal ends 508, 512 of the strap 504. Similar to the flexible touch fastener 116 shown and described above with reference to FIG. 1, the flexible touch fastener 516 is of a length sufficient to be secured about the first stop 136 or a first arm of the musical instrument stand 144 to releasably attach the musical instrument retainer 500 to the first stop 136 or the first arm. In some embodiments, as shown in FIG. 5, the flexible touch fastener 516 is a strip of hook-and-loop fastening tape with hooks on one side and loops on the other side, so that the fastener 516 can be secured around an arm of a musical instrument stand and overlapped on itself with the hooks engaged with the loops.

The musical instrument retainer 500 includes the rigid hook 520 attached to the end 508 of the two distal ends 508, 512 of the strap 504. The musical instrument retainer 500 also includes the latch 524 adjacent to the rigid hook 520. In some embodiments, the latch 524 is formed of metal or plastic. The latch 524 is configured to fit around the stop 140 of the musical instrument stand 144 shown in FIG. 1 and releasably secure the rigid hook 520 to the stop 140. In some embodiments, the latch 524 includes a flexible mechanism or spring that can be operated by a user to release the rigid hook 520 from the stop 140.

### Perspective View of Example Musical Instrument Retainer

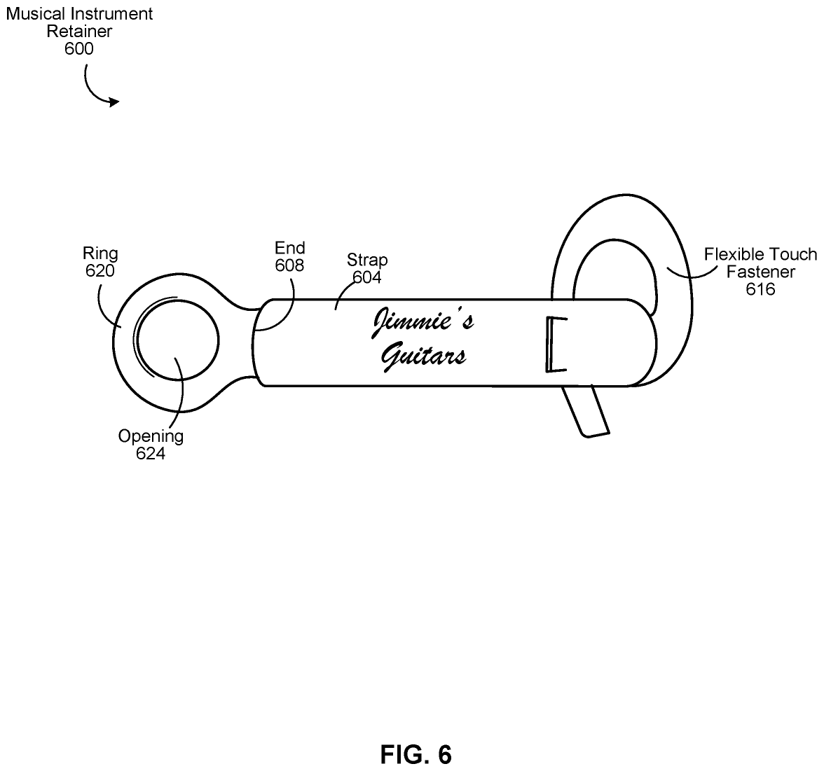

FIG. 6 shows a perspective view of yet another example musical instrument retainer 600. The musical instrument retainer 600 includes a strap 604, a flexible touch fastener 616, and a ring 620. The strap 604 is similar to the strap 404 illustrated and described in more detail above with reference to FIG. 4. The flexible touch fastener 616 is similar to the flexible touch fastener 516 illustrated and described in more detail above with reference to FIG. 5.

The musical instrument retainer 600 includes a circular or oval ring 620 attached to an end 608 of the strap 604. In some embodiments, the ring 620 is permanently attached to the end 608. The ring 620 can be glued or clamped onto the end 608 or otherwise attached to the end 608. The ring 620 defines an opening 624 that is sized to receive the second stop 140 of the musical instrument stand 144 shown in FIG. 1 to releasably attach the musical instrument retainer 600 to the second stop 140 of the musical instrument stand 144. The ring 620 can be formed of rubber, plastic, or metal, for example, and the opening 624 may be circular or oval in shape. In some embodiments, the musical instrument retainer 600 is of a length that, with the musical instrument retainer 600 positioned to prevent removal of the musical instrument 128 from between the stops 136 and 140, with the flexible touch fastener 616 secured about the first stop 136 and the ring 620 attached to the second stop 140, the strap 604 is held in a stretched condition.

1. A guitar neck retainer for releasably securing a neck of a guitar to a guitar stand having neck stops spaced apart so as to receive the neck of the guitar therebetween, the retainer comprising:
an elongated, longitudinally resiliently stretchable strap having two distal ends;
a flexible touch fastener permanently attached to one of the distal ends of the strap, the touch fastener comprising a strip of hook-and-loop fastening tape configured to be secured about a first of the neck stops of the guitar stand to releasably attach the retainer to the first neck stop of the guitar stand; and
a rigid hook permanently attached to the other of the distal ends of the strap, the hook defining a crook sized to receive a second of the neck stops of the guitar stand, to releasably attach the retainer to the second neck stop of the guitar stand,
wherein the retainer is of a length that, with the retainer positioned to prevent removal of the neck of the guitar from between the neck stops, with the touch fastener secured about the first neck stop and the hook attached to the second neck stop, the strap is held in a stretched condition.

2. The guitar neck retainer of claim 1, wherein the strap defines a compartment sized to accommodate a portion of a guitar pick.

3. The guitar neck retainer of claim 2, wherein the strap is configured to secure the portion of the guitar pick within the compartment when the portion of the guitar pick is inserted into the compartment through an opening in the strap.

4. The guitar neck retainer of claim 1, wherein the guitar neck retainer prevents the guitar from sliding out of or falling off the guitar stand when the retainer is positioned to prevent removal of the neck of the guitar from between the neck stops.

5. A musical instrument retainer for releasably securing a musical instrument to a musical instrument stand having stops spaced apart so as to receive the musical instrument therebetween, the retainer comprising:
an elongated, longitudinally resiliently stretchable strap having two distal ends;
a flexible touch fastener attached to one of the distal ends of the strap, the touch fastener comprising a strip of hook-and-loop fastening tape configured to be secured about a first of the stops of the musical instrument stand to releasably attach the musical instrument retainer to the first stop of the musical instrument stand; and
a rigid hook attached to the other of the distal ends of the strap, the hook defining a crook sized to receive a second of the stops of the musical instrument stand, to releasably attach the retainer to the second stop of the musical instrument stand.

6. The musical instrument retainer of claim 5, wherein the retainer is of a length that, with the retainer positioned to prevent removal of the musical instrument from between the stops, with the touch fastener secured about the first stop and the hook attached to the second stop, the strap is held in a stretched condition.

7. (canceled)

8. The musical instrument retainer of claim 5, wherein the strap is an elastic strap.

9. The musical instrument retainer of claim 5, wherein the strap has a compartment sized to accommodate a portion of a guitar pick.

10. The musical instrument retainer of claim 9, wherein the strap secures the portion of the guitar pick within the compartment when the portion of the guitar pick is inserted into the compartment through an opening in the strap.

11. The musical instrument retainer of claim 5, wherein the musical instrument retainer prevents the musical instrument from sliding out of or falling off the musical instrument stand when the retainer is positioned to prevent removal of the musical instrument from between the stops.

12. The musical instrument retainer of claim 5, wherein the rigid hook comprises plastic or metal.

13. The musical instrument retainer of claim 5, wherein the musical instrument retainer is a guitar neck retainer.

14. The musical instrument retainer of claim 5, wherein the musical instrument stand is a guitar stand.

15. The musical instrument retainer of claim 5, wherein the stops are spaced between 2 inches and 7 inches apart.

16. The musical instrument retainer of claim 5, wherein a length of the strap is around 1 inch.

17. The musical instrument retainer of claim 5, wherein the crook is sized to receive a stop of round cross-section having a diameter of between 0.25 inches and 3 inches.

18. The musical instrument retainer of claim 5, further comprising a latch attached to the other of the distal ends of the strap, the latch configured to releasably secure the rigid hook to the second stop of the musical instrument stand.

19. A musical instrument retainer for releasably securing a musical instrument to a musical instrument stand having stops spaced apart so as to receive the musical instrument therebetween, the retainer comprising:
an elongated, longitudinally resiliently stretchable strap having two distal ends;
a flexible touch fastener attached to one of the distal ends of the strap, the touch fastener configured to be secured about a first of the stops of the musical instrument stand to releasably attach the musical instrument retainer to the first stop of the musical instrument stand; and
a ring attached to the other of the distal ends of the strap, the ring defining an opening sized to receive a second of the stops of the musical instrument stand, to releasably attach the retainer to the second stop of the musical instrument stand.

20. The musical instrument retainer of claim 19, wherein the ring comprises at least one of rubber, plastic, or metal.

21. The guitar neck retainer of claim 1, wherein the rigid hook comprises plastic or metal.
